(19) United States
(12) Patent Application Publication
(10) Pub. No.: US 2013/0094901 A1
(43) Pub. Date: Apr. 18, 2013

(54) RADIALLY ALIGNED PLATES JOINED BY COMPRESSIVE FIT

(71) Applicant: SCHAEFFLER TECHNOLOGIES AG & CO. KG, Herzogenaurach (DE)

(72) Inventors: Markus Steinberger, Macedonia, OH (US); Spencer F. Hockeborn, Wooster, OH (US)

(73) Assignee: SCHAEFFLER TECHNOLOGIES AG & CO. KG, Herzogenaurach (DE)

(21) Appl. No.: 13/647,715

(22) Filed: Oct. 9, 2012

Related U.S. Application Data
(60) Provisional application No. 61/548,424, filed on Oct. 18, 2011.

(51) Int. Cl. F16B 5/07

(52) U.S. Cl. 403/364

(57) ABSTRACT

A plate assembly, including: a first plate having a circumference and a plurality of indentations extending radially inward or outward from the circumference; and a second plate, at least partially aligned with the first plate in a radial direction, having a plurality of protrusions at least partly disposed within the plurality of indentations and compressively engaged with the first plate such that the second plate is fixed with respect to the first plate in axial, radial, and circumferential directions.

### CROSS-REFERENCE TO RELATED APPLICATIONS

This application claims the benefit under 35 U.S.C. §119(e) of U.S. Provisional Application No. 61/548,424, filed Oct. 18, 2011.

### TECHNICAL FIELD

The present disclosure relates to radially aligned and connected plates, in particular, plates fixedly connected by a compressive fit.

### BACKGROUND

It is known to use rivets or staking to fix radially aligned plates to each other. The use of rivets entails the use of third components (the rivets) to connect two plates. Fabricating the plates for a rivet connection requires forming small cutouts in stamping tools, which reduces the life of the tools. Further, a high degree of precision is needed to align portions to be joined. Staking is not effective for transmitting torque.

### SUMMARY

According to aspects illustrated herein, there is provided a plate assembly, including: a first plate having a circumference and a plurality of indentations extending radially inward or outward from the circumference; and a second plate, at least partially aligned with the first plate in a radial direction, having a plurality of protrusions at least partly disposed within the plurality of indentations and compressively engaged with the first plate such that the second plate is fixed with respect to the first plate in axial, radial, and circumferential directions.

According to aspects illustrated herein, there is provided a plate assembly, including: a first plate having a circumference, a surface facing in an axial direction, and a plurality of indentations extending radially inward or outward from the circumference; and a second plate, at least partially aligned with the first plate in a radial direction, having a plurality of protrusions at least partly disposed within the plurality of indentations and compressively engaged with the first plate such that the second plate is fixed with respect to the first plate in axial, radial, and circumferential directions. Each protrusion in the plurality of protrusions includes a respective portion in contact with the surface.

According to aspects illustrated herein, there is provided a plate assembly, including: a first plate including: a first axial thickness, a circumference, a surface facing in an axial direction, and a plurality of indentations extending radially inward or outward from the circumference; and a second plate including: a second axial thickness greater than the first axial thickness, a first plurality of protrusions at least partly disposed within the plurality of indentations and compressively engaged with the first plate such that the second plate is fixed with respect to the first plate in axial, radial, and circumferential directions; and a second plurality of protrusions in contact with the surface. The first plate is axially centered with respect to the second plate.

These and other objects and advantages of the present disclosure will be readily appreciable from the following description of the invention and from the accompanying drawings and claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application; and,

FIG. 2 is a perspective view of an assembly of radially aligned joined plates;

FIG. 3 is a front view of the assembly of FIG. 2;

FIG. 4 is a cross-sectional view generally along line 4-4 in FIG. 3;

FIG. 5 is a detail of area 5 in FIG. 3;

FIG. 6 is a detail of area 6 in FIG. 4;

FIG. 7 is a partial cross sectional view generally along line 7-7 in FIG. 3;

FIG. 8 is a detail of area 6 in FIG. 4 showing a protrusion on the radially outermost plate;

FIG. 9 is a partial cross sectional view generally along line 9-9 in FIG. 8; and,

FIGS. 10A through 10F are details regarding the assembly in FIG. 2.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

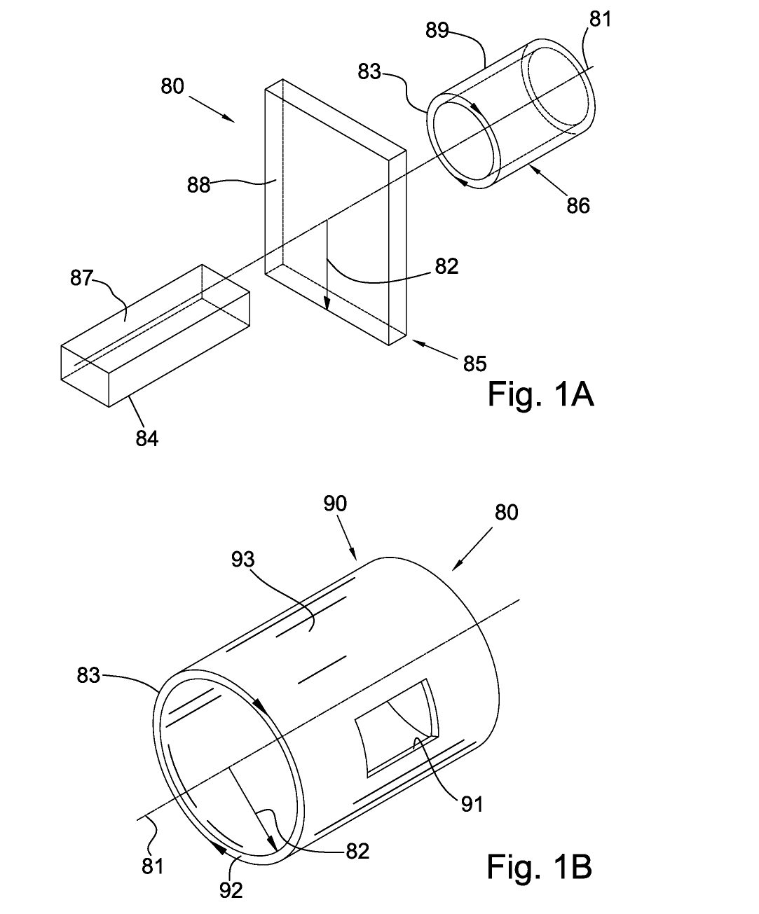

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is a circumferential surface.

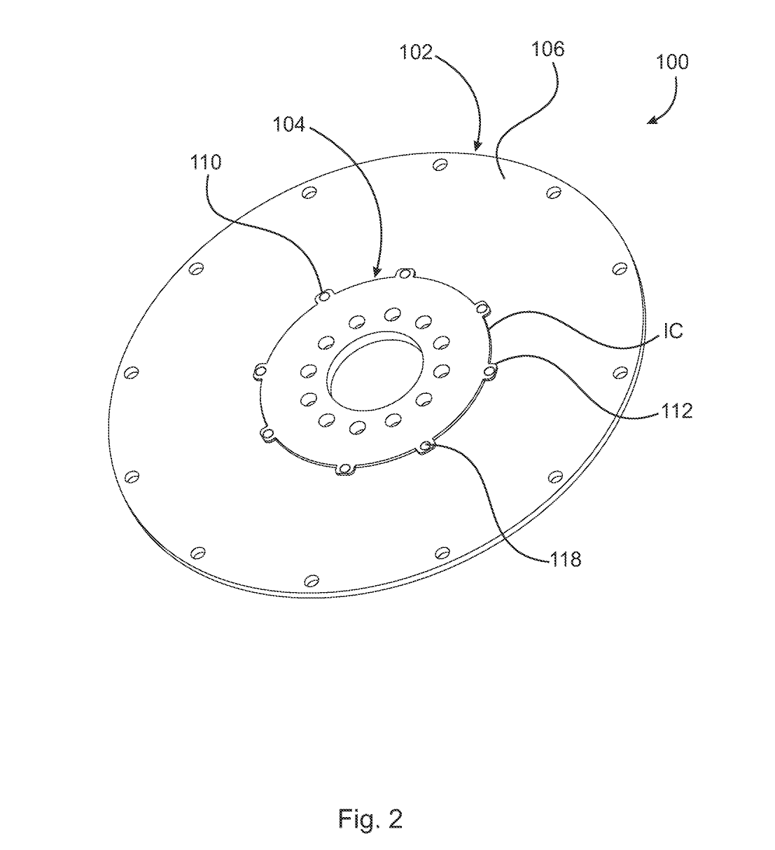

FIG. 2 is a perspective view of assembly 100 of radially aligned joined plates.

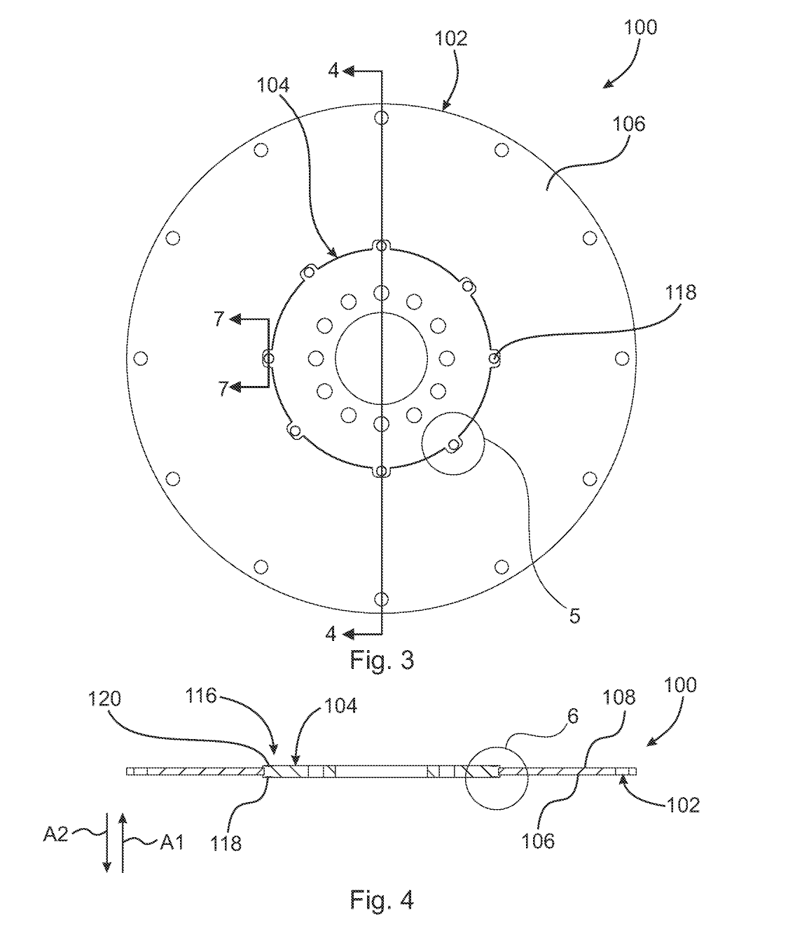

FIG. 3 is a front view of the assembly of FIG. 2.

FIG. 4 is a cross-sectional view generally along line 4-4 in FIG. 3.

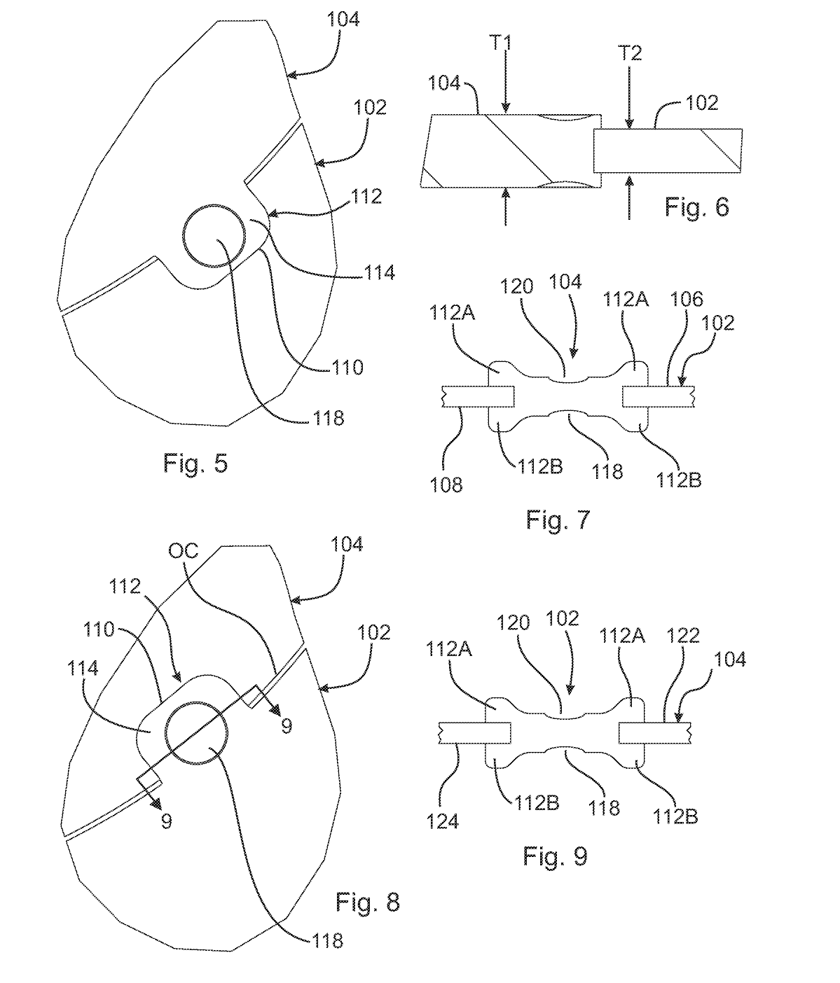

FIG. 5 is a detail of area 5 in FIG. 3.

FIG. 6 is a detail of area 6 in FIG. 4. The following should be viewed in light of FIGS. 2 through 6. Assembly 100 includes plates 102 and 104. One of plates 102 or 104 includes a plurality of indentations 110 extending radially inward or radially outward from the plate. The other of plates 102 or 104 includes a plurality of protrusions 112 at least partly disposed in indentations 110. In one embodiment, plate 102 includes inner circumference IC, surfaces 106 and 108, and plurality of indentations 110 extends radially outward from the inner circumference. Plate 104 is at least partially aligned with plate 102 in a radial direction and includes plurality of protrusions 112 at least partially disposed within the plurality of indentations and matingly engaged with the plurality of indentations. Protrusions 112 are compressively engaged with plate 102 such that plates 102 and 104 are fixed to each other in the axial, radial, and circumferential directions defined above.

In an example embodiment, protrusions 112 and indentations 110 have matching, mirrored, or symmetrical shapes. Plates 102 and 104 are formed such that the protrusions can be inserted in the indentations. The indentations are then compressed, for example, one or both of surfaces 114 and 116 are indented with a punch, in axial directions A1 and A2, respectively, such that the material forming the protrusions flows toward the indentations to form the compressive fit between the plates. As a result, protrusions 112 include indents 118 or 120 in surfaces 114 or 116, respectively.

FIG. 7 is a partial cross sectional view generally along line 7-7 in FIG. 3. The following should be viewed in light of FIGS. 2 through 7. In an example embodiment, the compression of protrusions 112 results in material from protrusions 112 overflowing onto one or both of surfaces 106 and 108. For example, one or both of portions 112A are in contact with surface 106 and one or both of portions 112B are in contact with surface 108. The overflowing of material from protrusions 112 onto surface 106 or 108 strengthens the fixed engagement of plates 102 and 104.

In an example embodiment, axial thickness T1 of the plate 104 is greater than axial thickness T2 of plate 102.

FIG. 8 is a detail of area 6 in FIG. 4 showing a protrusion on the radially outermost plate. In one embodiment, plate 104 includes outer circumference OC and plurality of indentations 110 extends radially inward from the outer circumference. Plate 102 is at least partially aligned with plate 104 in a radial direction and includes plurality of protrusions 112 at least partially disposed within the plurality of indentations and matingly engaged with the plurality of indentations. Protrusions 112 are compressively engaged with plate 102 such that plates 102 and 104 are fixed to each other in the axial, radial, and circumferential directions defined above.

As described above for FIGS. 2 through 6, for the configuration of FIG. 8, protrusions 112 and indentations 110 have matching, mirrored, or symmetrical shapes. Plates 102 and 104 are formed such that the protrusions can be inserted in the indentations. The indentations are then compressed, for example, one or both of surfaces 114 and 116 are indented with a punch, in axial directions A1 and A2, respectively, such that the material forming the protrusions flows toward the indentations to form the compressive fit between the plates. As a result, protrusions 112 include indents 118 or 120 in surfaces 114 or 116, respectively.

FIG. 9 is a partial cross sectional view generally along line 9-9 in FIG. 8. In an example embodiment, the compression of protrusions 112 results in material from protrusions 112 overflowing onto one or both of surfaces 122 and 124. For example, one or both of portions 112A are in contact with surface 122 and one or both of portions 112B are in contact with surface 124. The overflowing of material from protrusions 112 onto surface 122 or 124 strengthens the fixed engagement of plates 102 and 104.

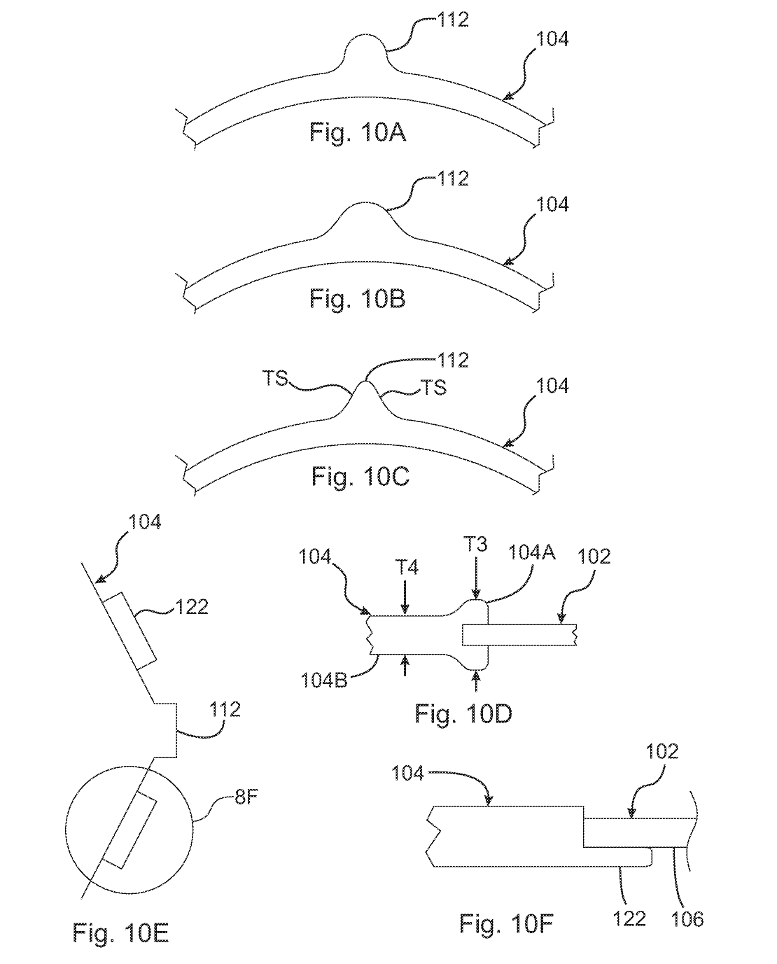

FIGS. 10A through 10C are details regarding the assembly in FIG. 2. The following should be viewed in light of FIGS. 2 though 7 and 10A through 10C. In example embodiments, as shown in FIGS. 10A through 10C, respectively, a shape, in a radial plane, for indentations 112 is semi-circular, elliptical shape, or triangular. The three shapes noted above cause torsional force applied to assembly 100 to have a radially inward component, which advantageously relieves stress in the corners of the protrusions. The circular shape enables good filling of the protrusions in the indentations, since the circular shape has better radial expansion than a rectangular shape. The elliptical shape reduces the bearing pressure area. For the triangular shape, the majority of the indentation to be filled is normal to triangle sides TS, so the amount of radial space to be filled in the indentations is minimized, which is advantageous since most of the load on the protrusions bears on the sides of the protrusions.

FIG. 10D is a detail regarding the assembly in FIG. 2. The following should be viewed in light of FIGS. 2 through 7 and 10D. In an example embodiment, as shown in FIG. 10D, axial thicknesses T3 of a portion 104A of plate 104, including protrusions 112, is greater than axial thickness T4 of portion 104B of plate 104. Advantageously, having T3 greater than T4 results in more volume for the protrusions, which enables more complete fill of the indentations. The extra material in portions 104A also creates a larger upset head and enables the use of greater axial force when indenting the protrusions.

FIGS. 10E and 10F are details regarding the assembly in FIG. 2. The following should be viewed in light of FIGS. 2 through 7, 10E, and 10F. In an example embodiment, as shown in FIG. 10E one or more centering lips 122 are formed on plate 104, for example, by a coining process. FIG. 10F shows plates 102 and 104 engaged such that lip 122 is in contact with surface 106 (it should be understood that plates 102 and 104 can be arranged such that lip 122 is in contact with surface 108). Lips 122 act to position plate 102 with respect to plate 104. In an example embodiment, lips 122 axially center plate 102 with respect to plate 104. For example, thicknesses T1, T2, and T5 are selected such that plate 102 is axially centered with respect to plate 104 when lips 122 are in contact with surface 106 or 108.

The discussion for FIGS. 10A through 10F is applicable to FIGS. 8 and 9.

In an example embodiment, plate 102 is a portion of a flange for a damper and plate 104 is a portion of a hub for the damper.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What we claim is:

1. A plate assembly, comprising:
a first plate having a circumference and a plurality of indentations extending radially inward or outward from the circumference; and,
a second plate, at least partially aligned with the first plate in a radial direction, having a first plurality of protrusions at least partly disposed within the plurality of indentations and compressively engaged with the first plate such that the second plate is fixed with respect to the first plate in axial, radial, and circumferential directions.

2. The plate assembly of claim 1, wherein:
each protrusion in the first plurality of protrusions includes a surface facing in an axial direction; and,
said each protrusion includes an indent in the surface.

3. The plate assembly of claim 1, wherein:
each protrusion in the first plurality of protrusions includes first and second surfaces facing in first and second opposite axial directions, respectively; and,
said each protrusion includes respective indents in the first and second surfaces.

4. The plate assembly of claim 1, wherein:
the first plate includes a surface facing in an axial direction; and,
each protrusion in the first plurality of protrusions includes a respective portion in contact with the surface.

5. The plate assembly of claim 1, wherein:
the first plate includes first and second surfaces facing in opposite axial directions; and,
each protrusion in the first plurality of protrusions includes a portion in contact with the first or second surface.

6. The plate assembly of claim 1, wherein an axial thickness of the second plate is greater than an axial thickness of the first plate.

7. The plate assembly of claim 1, wherein an axial thicknesses of a first portion of the second plate, including the plurality of protrusions, is greater than an axial thickness a second portion of the second plate wholly different from the first portion of the second plate and in contact with the first portion.

8. The plate assembly of claim 1 wherein:
the first plate includes a surface facing in an axial direction;
the second plate includes a second plurality of protrusions in contact with the surface; and,
the first plate is axially centered with respect to the second plate.

9. The plate assembly of claim 1, wherein a shape, in a radial plane, for each protrusion in the first plurality of protrusions is selected from the group consisting of a semi-circular shape, an elliptical shape, and a triangular shape.

10. The plate assembly of claim 1, wherein the first plate is a portion of a flange for a damper and the second plate is a portion of a hub for the damper.

11. A plate assembly, comprising:
a first plate having an circumference, a surface facing in an axial direction, and a plurality of indentations extending radially inward or outward from the circumference; and,
a second plate, at least partially aligned with the first plate in a radial direction, having a plurality of protrusions at least partly disposed within the plurality of indentations and compressively engaged with the first plate such that the second plate is fixed with respect to the first plate in axial, radial, and circumferential directions, wherein each protrusion in the plurality of protrusions includes a respective portion in contact with the surface.

12. A plate assembly, comprising:
a first plate including a circumference, a first axial thickness, a surface facing in an axial direction, and a plurality of indentations extending radially inward or outward from the circumference; and,
a second plate including:
a second axial thickness greater than the first axial thickness;
a first plurality of protrusions at least partly disposed within the plurality of indentations and compressively engaged with the first plate such that the second plate is fixed with respect to the first plate in axial, radial, and circumferential directions; and,
a second plurality of protrusions in contact with the surface, wherein the first plate is axially centered with respect to the second plate.
